(19) United States
(12) Patent Application Publication
(10) Pub. No.: US 2005/0281423 A1
(43) Pub. Date: Dec. 22, 2005

(54) In-ear monitoring system and method

(76) Inventors: Stephen W. Armstrong, Burlington (CA); Brad Marshall, Kitchener (CA)

Correspondence Address: STEPHEN D. SCANLON, JONES DAY, 901 LAKESIDE AVENUE, CLEVELAND, OH, 44114, US

(21) Appl. No.: 11/158,636

(22) Filed: Jun. 22, 2005

Related U.S. Application Data
(60) Provisional application No. 60/581,668, filed on Jun. 22, 2004.

(51) Int. Cl. H04R 25/00

(52) U.S. Cl. 381/311

(57) ABSTRACT

An in-ear monitor system facilitates stereo depth perception using microphones at each ear, minimizes occlusion effects, and provides a digital platform for both audio digital signal processing and wireless transmission.

### REFERENCE TO RELATED APPLICATIONS

This patent application claims the benefit of priority to U.S. Provisional Application Ser. No. 60/581,668, entitled “In Ear Monitoring System And Method,” filed on Jun. 22, 2004, the entire disclosure of which is incorporated herein by reference.

This patent application is related to U.S. Patent Application Ser. No. 11/______, entitled “In-Ear Monitoring System And Method With Bidirectional Channel,” filed on Jun. 22, 2005, and U.S. Patent Application Ser. No. 11/______, entitled “First Person Acoustic Environment System And Method,” filed on Jun. 22, 2005, the disclosures of which are incorporated herein by reference.

### BACKGROUND AND SUMMARY

This disclosure relates in general to hearing instruments, and in particular relates to in-ear monitor (IEM) systems and methods.

In-ear monitors often plug the ear completely to allow an external mix of the acoustical environment to be provided to a user while minimizing outside interference. This results in a clean mix of the separate instruments and vocals that are being played within a musical setting, but limits the wearer's ability to control the wearer's own preferred sound mix, and also limits the wearer's ability to discern acoustical changes caused by the wearer's position on stage or in the studio.

The systems and methods described herein facilitate the monitoring and control of a wearer's acoustical environment. For example, the systems and methods described herein may assist musicians in taking better control over their acoustical environment while playing live or in a studio. A wearer, such as a musical artist, is provided with a digital wireless communication digital signal processing (DSP) based IEM system. The IEM comprises monitors for each ear, and has external microphones at each ear for depth perception and directionality. The IEM may also include a microphone that is placed in the ear to compensate for occlusion effects from partially or completely occluding the ear canal, and may also include an input for an external monitor mix input. The IEM may also include a microphone that is placed in the ear to provide a bidirectional communication channel over which the wearer may communicate with other parties.

The systems and methods disclosed herein may be used by musicians playing live either on stage or in the studio, and may be used to develop a virtual audio environment for listeners of pre-recorded or live music. Additionally, the systems and methods described herein may be used by third persons to experience a first-person acoustical environment either in real-time or by playback.

### DRAWINGS

FIG. 1 is a block diagram of an in-ear monitoring component package for a wearer;

FIG. 2 is a block diagram of a first example in-ear monitor system configuration;

FIGS. 3 and 4 are example compression curves applied to an external microphone;

FIG. 5 is a block diagram of a second example in-ear monitor system configuration;

FIG. 6 is a block diagram of a third example in-ear monitor system configuration;

FIG. 7 is a flow diagram of a process of providing ambient compression to an ambient electrical signal;

FIG. 8 is a flow diagram of a process of wireless in-ear monitoring;

FIG. 9 is a flow diagram of a process of providing occlusion cancellation in an in-ear monitor;

FIG. 10 is a flow diagram of a process of providing a bidirectional voice channel via in-ear monitors;

FIG. 11 is a flow diagram of a process of providing a first-person acoustical environment; and

FIG. 12 is a flow diagram of a process of providing a first-person acoustical environment to one or more remote sound reproduction devices.

### DETAILED DESCRIPTION

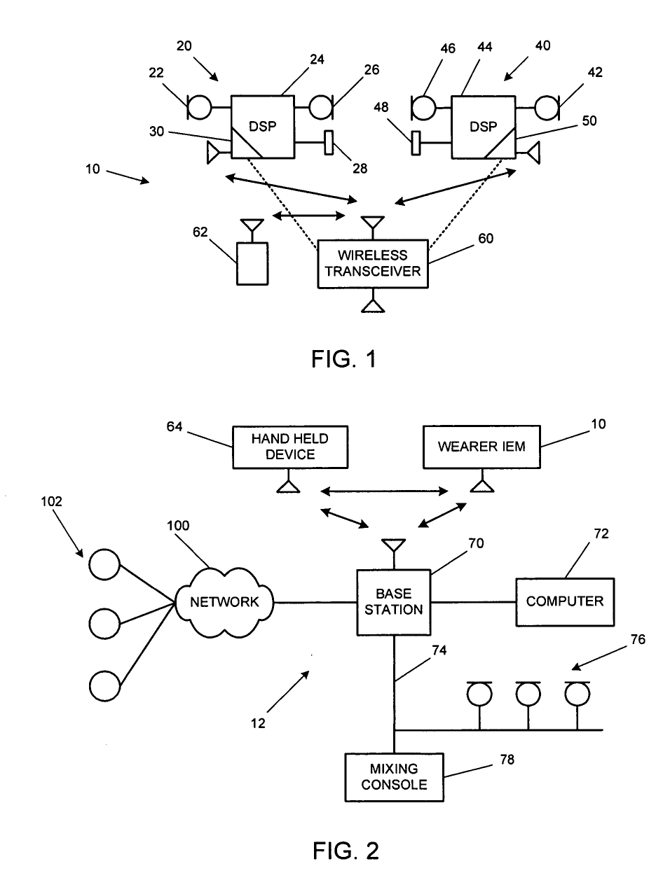

FIG. 1 is a block diagram of an in-ear monitoring component package 10 for a wearer, such as a musician or entertainment performer. The component package 10 comprises first and second in-ear monitors 20 and 40 and a wireless transceiver 60 that is associated with the wearer. The first in-ear assembly 20 comprises an outside microphone 22, a DSP device 24, an occlusion microphone 26, a transducer 28, and a communication subsystem 30. The outside microphone 22 receives sounds from the ambient acoustic environment external to the wearer and converts the sounds into corresponding electrical signals that are, in turn, provided to the DSP device 24.

The occlusion effect is the amplification of the wearer's own biologic sounds and voice within the ear canal. The occlusion microphone 26 is thus inside the ear canal to receive this unwanted signal created by the occlusion effect. The occlusion microphone 26 receives sounds from the wearer's inner ear and converts the sounds into corresponding electrical signals that are, in turn, provided to the DSP device 24 for occlusion cancellation. One example occlusion cancellation system is disclosed in U.S. patent application Ser. No. 10/121,221, entitled “Digital Hearing Aid System,” and filed on Apr. 12, 2002, now U.S. Pat. No. ______, the entire disclosure of which is incorporated herein by reference.

The DSP device 24 receives the electrical signals from the outside microphone 22 and the occlusion microphone 26. Additionally, the DSP device 24 also receives a mix signal from a wireless base station 70, which is described in FIG. 2. The output of the DSP device 24 drives the transducer 28, which in turn provides an acoustic signal heard by the wearer.

A second in-ear assembly 40 comprises an outside microphone 42, a DSP device 44, an occlusion microphone 46, a transducer 48, and a communication subsystem 50. The second in-ear assembly 40 is similar in construction and operation to the first in-ear assembly 20. The two in-ear assemblies 20 and 40 are combined to provide left- and right-channel processing, respectively.

The acoustic signal heard by the wearer has a reduced occlusion characteristic due to the occlusion cancellation provided by the DSP device 24 and the occlusion microphone 26. Additionally, the acoustic signal heard by the wearer may provide depth perception and ambient sound via the outside microphones 22 and 42.

The in-ear assemblies 20 and 40 may utilize one or more digital transmission protocols to send and receive audio and data information to and from the base station 70. Such standards include IEEE 802.11b, Bluetooth, and the like, or proprietary communication protocols.

Alternatively, a secondary wireless transceiver 60 may be worn by the wearer for wireless transmissions to the base station. In one example configuration, the wireless transceiver 60 communicates with the base station 70 over a first communication protocol, and communicates with the in-ear assemblies 20 and 40 over a second communication protocol. The second communication protocol may be a wireless communication protocol, as illustrated in FIG. 1. The communication subsystems 30 and 50 of the first and second in-ear monitors 20 and 40 may alternatively be directly wired to the wireless transceiver 60, as indicated by the dashed wired configuration, in which case the second communication protocol may be a wired communication protocol.

The outputs of the in-ear assemblies 20 and 40 may be transmitted to a digital recording device for facilitating a virtual audio environment for later listening. The output signals may be transmitted over a wireless communication protocol to the recording device if the communication subsystems 30 and 50 are wireless communication systems, or may be transmitted via the wireless transceiver 60.

Peripheral systems 62 may also communicate with the wireless transceiver 60 and/or the in-ear assemblies 20 and 40. Such peripheral systems may include other component packages 10 or other base stations 70 that may be selected by the user of the component package 10. A plurality of component packages 10 may be addressed for selection by one or more wearers or other persons. For example, a wearer may selectively listen to another wearer's in-ear assembly outputs by selecting another addressed component package 10 via the wireless transceiver 60.

In another example system configuration, one or both of the occlusion microphones 26 and 46 may alternatively provide a voice input for a bidirectional voice communication channel. Alternatively, a voice input may be provided from the outside microphone 22 or from an externally mounted microphone, such as a boom microphone or a lapel microphone. The bidirectional voice communication channel may be selectively enabled by the wearer of the first and second in-ear monitors 20 and 40, or be automatically enabled upon receiving a voice communication signal over the wireless transceiver 60. When a wearer desires to speak to another wearer of an addressed component package 10, or another person, such as mixing technician at a front-of-housing mixing station, the wearer may activate the bidirectional voice channel and select the person with whom the wearer desires to speak. In addition to being unicast, the voice communication may be multicast or broadcast so one wearer may communicate with multiple wearers over the bidirectional voice channel.

The wireless transceiver 60 may also be configured to facilitate adjustment of the in-ear assemblies 20 and 40. The wireless transceiver 60 may thus include external manual controls, such as mix selection, volume adjustment, and the like, that may be adjusted by the user according to the user's preference.

In an alternate configuration, the wireless transceiver 60 may be configured to provide digital signal processing of the DSP devices 24 and 44 of the in-ear monitors 20 and 40. Accordingly, the in-ear monitors 20 and 40 may thus only provide basic audio input/output functions, and do not require separate DSP devices 24 and 44.

FIG. 2 is a block diagram of a first example in-ear monitor system configuration 12. A mixing console 78 receives signal inputs from vocal microphones and instrument outputs 76 and outputs an acoustic data signal. The acoustic data signal may facilitate channel selection so that a user may select or adjust particular vocal or instrument inputs.

The mixing console 78 may be a digital processing device, and the vocal microphones and instrument outputs 76 may be provided over a multi-channel cable or digital control wire 74. The mixing console 78 may be implemented in a front-of-house mixing board that is typically located at the front of a musical venue.

A base station 70 receives vocal microphones and instrument outputs 76 and digitally mixes the inputs. The base station 70 may be implemented as a monitor mix board. Alternatively, the base station 70 and the mixing console 78 may be implemented in a single acoustic processing device. The base station 70 may receive both analog microphone inputs and digital microphone inputs.

The base station 70 may also include docking ports for the individual wireless transceivers 60 for each component package 10, and may be configured to individually address multiple component packages 10 for individual selection, control and communication. The base station 70 may provide multiple mixes that can be controlled by the musical artist via a hand held device 64 or a monitor technician, and transmit the mix signals over a wireless communication protocol to one or more component packages 10.

The base station 70 may have digital protocols that control the adjusted parameters at the microphone so that equalization, compression, gain structure and polar patterns can be controlled at the base station 70. Accordingly, the in-ear monitoring system 12 provides a simpler platform that facilitates an overall cleaner sound and lower noise floor. The base station 70 may also implement additional digital signal processing for equalization, compression and acoustic effects.

The hand held device 64 may be implemented as a wireless implement to control parameters at the base station 70 and/or the in-ear assemblies 20 and 40. The hand held device 64 functionality may also be incorporated into the wireless transceiver 60 of the wearer's component package 10.

An external computer 72 may be used to control the digital interface to the base station 70 if a monitor technician is required. The base station 70 may alternatively be connected to the network 100, such as the Internet, so that a monitor technician need not be present at the venue to make changes or provide services.

While acoustic data processing may be distributed as illustrated in FIG. 2, in another example system, the mixing console 78, the base station 70 and the computer 72 may be combined into a single acoustic data processing device. Additionally, by addressing a plurality of pairs of first and second in-ear assembly component packages 10, only one acoustic data processing device is required to facilitate monitoring of an entire venue. Additional remote base stations 70 may be further distributed throughout a large venue area to eliminate transmission dead spots.

Settings for each component package 10 may be stored in a memory store of the in-ear monitor assemblies 20 and 40, or in an associated wireless transceiver 60, or in the base station 70 or computer 72. The memory store may comprise a FLASH memory device or other type of memory device.

Additionally, on-board reverb and spatial effects may be stored in digital format and shared with other wearers who desire unique acoustics or setting to obtain a desired performance out of the in-ear monitors they are wearing. Such shared settings may include parameters for digital wireless transmission and layouts of input mixes, personal mixes for particular artists, and the like.

The in-ear monitor settings may be provided over the network 100, such as the Internet, to remote listeners 102 in an online community. Alternatively, the in-ear monitor settings may be provided by directly connecting to the system 12, or by a removable memory device, such as a FLASH memory device, or by other data sharing and/or transmission methods.

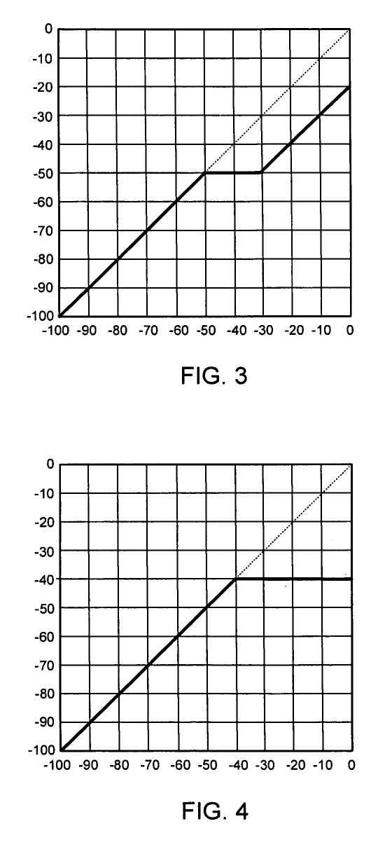

FIGS. 3 and 4 are example compression curves applied to an external microphone output of an in-ear assembly. The compression is graphically depicted by the bold gain curves deviating from unity gain. The compression curves may be utilized to limit the sound level of the ambient acoustic environment so that the wearer of the in-ear monitor assemblies 20 and 40 may hear a clean mix of the separate instruments and vocals that are being generated within a musical setting. Additionally, the compression curve may be configured to provide hearing protection. The hearing protection may be further configured to provide a flat spectral loss.

Such compression may be selectively enabled, e.g., compression may be enabled during the playing of songs and disabled in between songs so that the wearer may fully experience the ambient acoustic environment or carry on personal conversations with other musicians or members of the audience in between songs. The compression may be configured to scale the output signal in excess of a particular sound pressure level, as shown in FIG. 3, or may be configured to limit the output signal to a given sound pressure level, as shown in FIG. 4. Other compression curves may also be used.

The compression of FIGS. 3 and 4 may also be applied to other signals, such as the mix signal. Additionally, compression may be selectively applied to particular signals, such as a voice signal or a particular instrument.

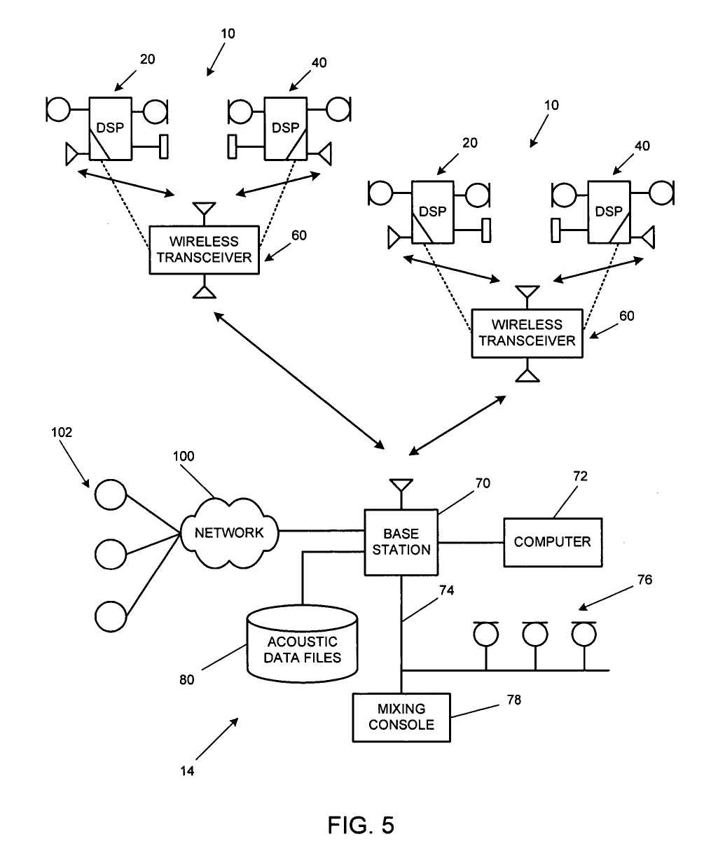

FIG. 5 is a block diagram of a second example in-ear monitor system configuration 14. The in-ear monitor system configuration 14 of FIG. 5 is similar to the system configuration of FIG. 2, except that the base station 70 is further configured to store modulated mixes of acoustic electrical signals in acoustic data files 80. The acoustic data files 80 may store right- and left-channel sound outputs for one or more pairs of addressed in-ear monitors 20 and 40. The acoustic data files may be accessed over the network 100 by remote listeners 102. The remote listeners 102 may access the base station 70 over the network 100 to select one or more acoustic data files 80 for playback. Playback devices may include speakers, headphones, and the like.

In one example configuration, the playback devices comprise in-ear monitoring devices that reproduce the acoustic environment in the same manner that corresponding in-ear monitors 20 and 40 provide the acoustic environment for the wearer. This example configuration provides a virtual audio environment for listening to pre-recorded performances from a particular point of view, such as that of the performer, and also provide for remote technician service and monitoring.

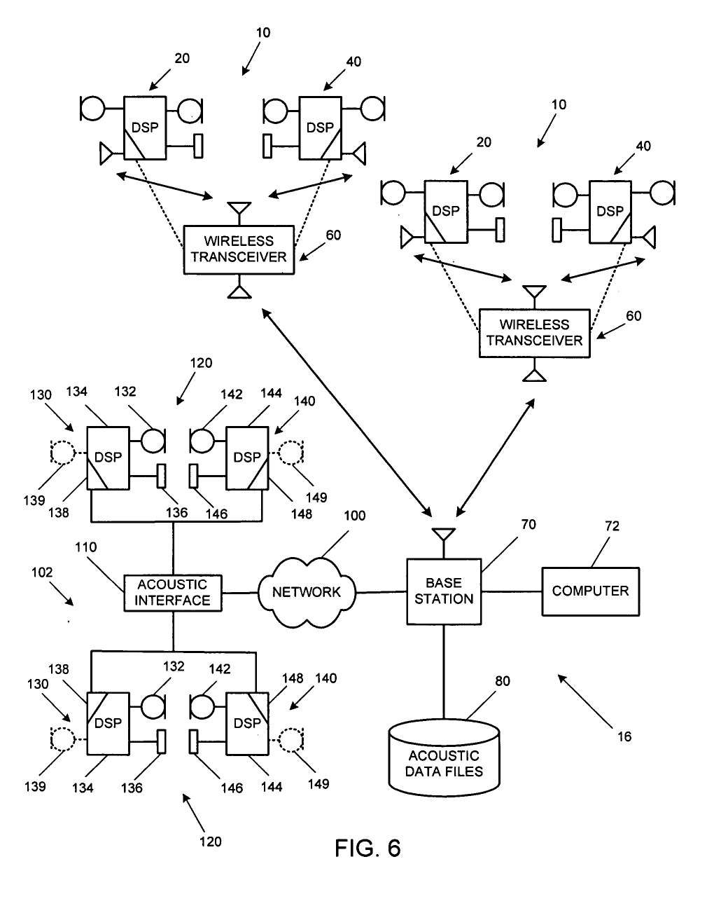

FIG. 6 is a block diagram of a third example in-ear monitor system configuration 16. The in-ear monitoring system configuration 16 provides a first-person acoustical environment for one or more remote listeners. Acoustic signals heard by the wearers of component packages are electrically transmitted to the base station 70, which, in turn, is configured to provide the acoustic signal data to one or more remote listeners 102.

An example remote listener 102 comprises an acoustic interface 110 and one or more in-ear playback devices 120. The acoustic interface 110 may comprise a computer or special-purpose terminal. A right-channel in-ear playback device 130 comprises an occlusion microphone 132, a DSP device 134, a transducer 136, and a communication subsystem 138, and a left-channel in-ear playback device 140 comprises an occlusion microphone 142, a DSP device 144, a transducer 146, and a communication subsystem 148. The in-ear playback devices operate in a manner similar to the in-ear monitor assemblies 20 and 40 to accurately recreate for a third person the acoustic environment heard by the wearer of the in-ear assemblies 20 and 40.

The playback devices 120 may also include outside microphones 139 and 149 that receive sounds from the ambient acoustic environment external to the wearers of the playback devices 120 and converts the sounds into corresponding electrical signals that are, in turn, provided to the DSP devices 134 and 144 for processing. Processing of the outside microphones 139 and 149 output may be selectively enabled by the wearers.

The base station 70 may be further configured to address a plurality of pairs of first and second in-ear assemblies 20 and 40 and to receive user selection from a user of a remote listener 102 to selectively provide the ambient electrical signals for a selected addressed pair of first and second in-ear assemblies 20 and 40 to the in-ear playback devices 120 worn by the user. The ambient electrical signals for each pair of first and second in-ear assemblies 20 and 40 may be stored in acoustic data files 80 for buffering or later access.

The acoustic data files 80, and/or the ambient electrical signals may comprise compressed or uncompressed digital audio data. Typically there is a small time delay t_{d} for converting analog ambient electrical signals into the compressed or uncompressed digital audio data. The time delay t_{d} is of little consequence if the remote users are listening to an audio-only performance, e.g., a symphony being audio-only broadcast over the network 100. If, however, the performance includes a video broadcast over the network 100, then the video broadcast may be buffered and delayed so that the remote users receive both the audio and video data as a simulcast.

The example configuration 16 of FIG. 6 allows users to hear a variety of venues and performances in a unique first-person acoustic environment. For example, a user of the remote listener 102 may hear the exact acoustic environment of a conductor of a symphony orchestra; as the conductor moves or changes positions, so changes the acoustic environment of the conductor. This change is then experienced by the users of the remote listeners 102.

Users may also experience other types of performances in a first-person acoustic environment. For example, athletes may be outfitted with the in-ear assemblies 20 and 40, and a user of the remote listener 102 may then experience the actual acoustic environment of the athlete while viewing a sporting event either in a live setting or via a broadcast over the network 100.

The user of the remote listener 102 may select particular athletes when viewing the sporting event. For example, a user may select and experience the actual acoustic environment of a quarterback during one play in a football game, and may later select and experience the actual acoustic environment of a running back during another play in the football game.

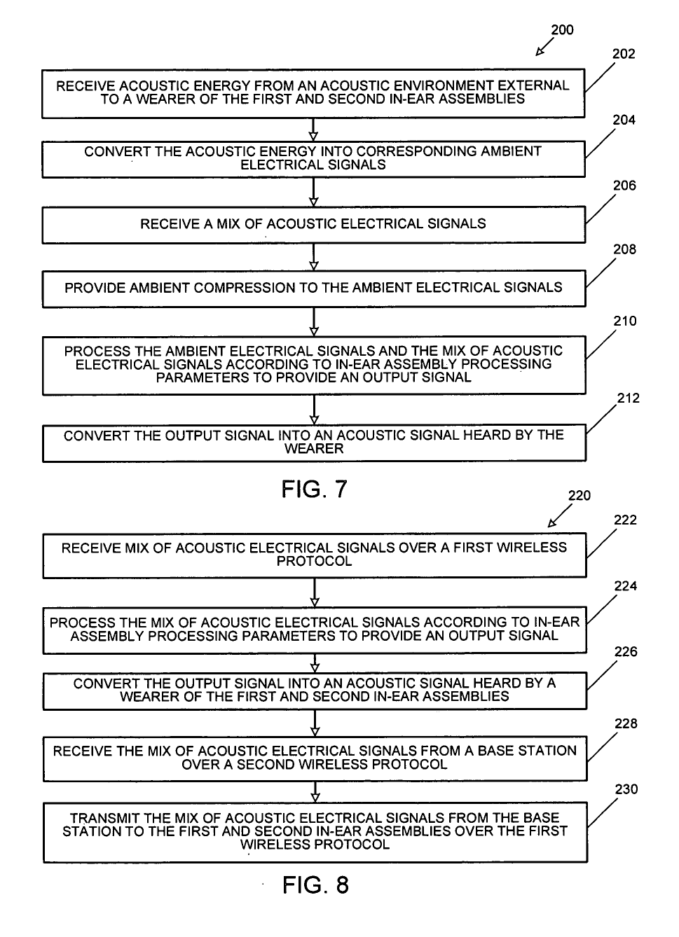

FIG. 7 is a flow diagram 200 of a process of providing ambient compression to an ambient electrical signal. Step 202 receives acoustic energy from an acoustic environment external to a wearer of the first and second in-ear assemblies. Step 204 converts the acoustic energy into corresponding ambient electrical signals. Step 206 receives a mix of acoustic electrical signals. The mix may comprise voice and instrument signals. Step 208 provides ambient compression to the ambient electrical signals. Step 210 processes the ambient electrical signals and the mix of acoustic electrical signals according to in-ear assembly processing parameters to provide an output signal. Step 212 converts the output signal into an acoustic signal heard by the wearer.

FIG. 8 is a flow diagram 220 of a process of wireless in-ear monitoring. Step 222 receives a mix of acoustic electrical signals over a first wireless protocol. Step 224 processes the mix of acoustic electrical signals according to in-ear assembly processing parameters to provide an output signal. Step 226 converts the output signal into an acoustic signal heard by a wearer of the first and second in-ear assemblies. Step 228 receives the mix of acoustic electrical signals from a base station over a second wireless protocol. Step 230 transmits the mix of acoustic electrical signals from the base station to the first and second in-ear assemblies over the first wireless protocol.

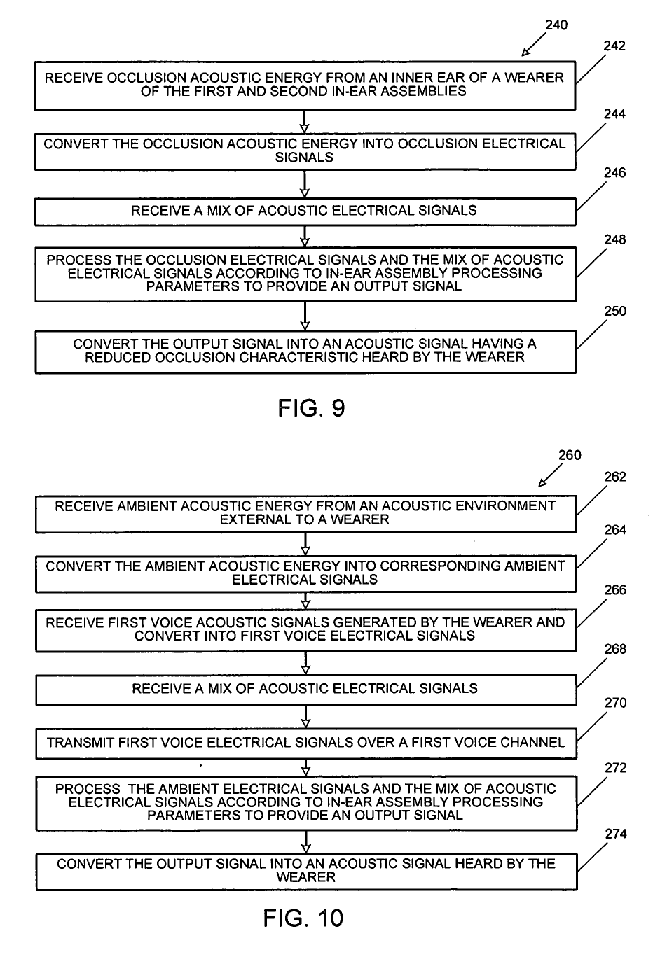

FIG. 9 is a flow diagram 240 of a process of providing occlusion cancellation in an in-ear monitor. Step 242 receives occlusion acoustic energy from an inner ear of a wearer of the first and second in-ear assemblies. Step 244 converts the occlusion acoustic energy into occlusion electrical signals. Step 246 receives a mix of acoustic electrical signals. Step 248 processes the occlusion electrical signals and the mix of acoustic electrical signals according to in-ear assembly processing parameters to provide an output signal. Step 250 converts the output signal into an acoustic signal having a reduced occlusion characteristic heard by the wearer.

FIG. 10 is a flow diagram 260 of a process of providing a bidirectional voice channel via in-ear monitors. Step 262 receives ambient acoustic energy from an acoustic environment external to a wearer. Step 264 converts the ambient acoustic energy into corresponding ambient electrical signals. Step 266 receives first voice acoustic signals generated by the wearer and converts the first voice acoustic signals into first voice electrical signals. Step 268 receives a mix of acoustic electrical signals. Step 270 transmits the first voice electrical signals over a first voice channel. Step 272 processes the ambient electrical signals and the mix of acoustic electrical signals according to in-ear assembly processing parameters to provide an output signal. Step 274 converts the output signal into an acoustic signal heard by the wearer.

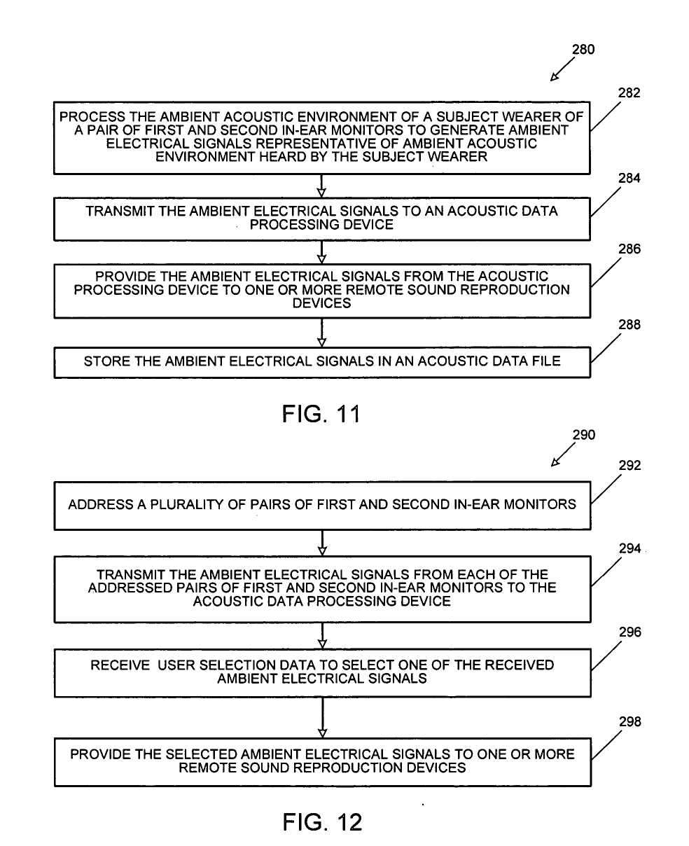

FIG. 11 is a flow diagram 280 of a process of providing a first-person acoustic environment. Step 282 processes the ambient acoustic environment of a subject wearer of a pair of first and second in-ear monitors to generate ambient electrical signals representative of an ambient acoustic environment heard by the subject wearer. Step 284 transmits the ambient electrical signals to an acoustic data processing device. Step 286 provides the ambient electrical signals from the acoustic processing device to one or more remote sound reproduction devices. Step 288 stores the ambient electrical signals in an acoustic data file.

FIG. 12 is a flow diagram 290 of a process of providing a first-person acoustical environment to one or more remote sound reproduction devices. Step 292 addresses a plurality of pairs of first and second in-ear monitors. Step 294 transmits the ambient electrical signals from each of the addressed pairs of first and second in-ear monitors to the acoustic data processing device. Step 296 receives user selection data to select one of the received ambient electrical signals. Step 298 provides the selected ambient electrical signals to one or more remote sound reproduction devices.

The in-ear monitoring systems and methods described herein thus may provide personalized equalizing and dynamic settings for each ear of the wearer, and personal control over unique mixes for each wearer. Individual microphones placed at each ear provide direct input from the wearer's acoustical environment. The in-ear monitoring system and methods reduce occlusion effects, thus making the use of the in-ear monitoring a more transparent experience. Additionally, the in-ear monitoring systems and methods described herein may also provide hearing compensation for hearing-impaired musicians, and thus may be readily used by hearing impaired musicians. Additionally, the storing of digital settings and digital audio data for the in-ear monitoring systems herein also provide for online community sharing of the settings with other technicians and musicians, and virtual audio environments for listening to performances from a particular point of view. The programmable features of the digital systems also provide for efficient implementation of software upgrades over time, and for flexibility in implementation with existing systems. The in-ear monitoring systems and methods disclosed herein provide depth perception and directionality of sounds external to a wearer and allow the wearer to control of the mix between the wearer's personal acoustic environment and a monitor mix, and also provide for communication with other wearers.

The embodiments described herein are examples of structures, systems or methods having elements corresponding to the elements of the invention recited in the claims. This written description may enable those of ordinary skill in the art to make and use embodiments having alternative elements that likewise correspond to the elements of the invention recited in the claims. The intended scope of the invention thus includes other structures, systems or methods that do not differ from the literal language of the claims, and further includes other structures, systems or methods with insubstantial differences from the literal language of the claims.

1. An in-ear monitoring system, comprising:
first and second in-ear assemblies, each in-ear assembly comprising:
an outside microphone configured to receive acoustic energy from an acoustic environment external to a wearer and convert the acoustic energy into corresponding ambient electrical signals;
a communication subsystem configured to receive a mix of acoustic electrical signals;
a digital signal processing (DSP) circuit configured to receive the ambient electrical signals and the mix of acoustic electrical signals and provide ambient compression to the ambient electrical signals, and to further process the ambient electrical signals and the mix of acoustic electrical signals according to in-ear assembly processing parameters to provide an output signal; and
an output transducer configured to receive the output signal and convert the output signal into an acoustic signal heard by the wearer.

2. The in-ear monitoring system of claim 1, wherein:
the DSP circuit is further configured to provide the ambient compression only during the presence of ambient compression activation signal.

3. The in-ear monitoring system of claim 1, wherein:
the ambient compression limits the ambient sound pressure level (SPL) to a maximum ambient SPL threshold level.

4. The in-ear monitoring system of claim 1, further comprising:
a wireless transceiver configured to receive the mix of acoustic electrical signals from a base station over a first wireless communication protocol and transmit the mix of acoustic electrical signals to the communication subsystem in the first and second in-ear assemblies.

5. The in-ear monitoring system of claim 4, wherein:
the mix of acoustic electrical signals comprise a plurality of acoustic channels, and wherein the wireless transceiver is configured to provide a user interface for selective adjustment of each acoustic channel by the wearer.

6. The in-ear monitoring system of claim 5, wherein:
the selective adjustment of each acoustic channel comprises selective frequency equalization of each acoustic channel.

7. The in-ear monitoring system of claim 4, wherein:
the communication subsystem in the first and second in-ear assemblies is a wireless communication subsystem; and
the wireless transceiver is further configured to transmit the mix of acoustic electrical signals to the first and second in-ear assemblies over a second wireless communication protocol.

8. The in-ear monitoring system of claim 4, further comprising:
a mixing station in communication with the base station and configured to receive vocal and instrument signals and generate the mix of acoustic electrical signals; and
wherein the base station is configured to address a plurality of paired first and second in-ear assemblies and modulate the mix of acoustic electrical signals according to the first processing settings associated with each pair of first and second in-ear assemblies and to address the modulated mixes of acoustic electrical signals to correspondingly addressed paired first and second in-ear assemblies.

9. The in-ear monitoring system of claim 8, wherein:
the wireless transceiver is further configured to selectively receive the modulated mixes of acoustic electrical signals based on a user selection.

10. The in-ear monitoring system of claim 8, wherein:
the base station is further configured to store the modulated mixes of acoustic electrical signals in acoustic data files.

11. The in-ear monitoring system of claim 10, wherein:
the wireless transceiver is further configured to selectively access the stored acoustic data files over the first wireless communication protocol for playback by the first and second in-ear assemblies.

12. The in-ear monitoring system of claim 1, wherein:
each first and second in-ear assembly further comprise:
an occlusion microphone configured to receive occlusion acoustic energy from the wearer's inner ear and convert the sounds into occlusion electrical signals; and
wherein each DSP circuit is further configured to receive and process the occlusion electrical signals so that the generated output signal has a reduced occlusion characteristic.

13. An in-ear monitoring system, comprising:
first and second in-ear assemblies, each in-ear assembly comprising:
a wireless communication subsystem configured to receive a mix of acoustic electrical signals;
a digital signal processing (DSP) circuit configured to receive the mix of acoustic electrical signals, and to further process the mix of acoustic electrical signals according to in-ear assembly processing parameters to provide an output signal; and
an output transducer configured to receive the output signal and convert the output signal into an acoustic signal heard by a wearer; and
a wireless transceiver configured to be proximate to the first and second in-ear assemblies and configured to receive the mix of acoustic electrical signals from a base station over a first wireless communication protocol and transmit the mix of acoustic electrical signals to the first and second in-ear assemblies over a second wireless communication protocol.

14. The in-ear monitoring system of claim 13, wherein:
the first wireless communication protocol conforms to a wireless local area network (WLAN) protocol and the second wireless communication protocol conforms to a personal area network (PAN) protocol.

15. The in-ear monitoring system of claim 13, wherein:
the base station is configured to address a plurality of paired first and second in-ear assemblies and modulate the mix of acoustic electrical signals according to the first processing settings associated with each pair of first and second in-ear assemblies and to address the modulated mixes of acoustic electrical signals to correspondingly addressed paired first and second in-ear assemblies.

16. The in-ear monitoring system of claim 15, wherein:
the wireless transceiver is further configured to selectively receive the modulated mixes of acoustic electrical signals based on a user selection.

17. The in-ear monitoring system of claim 15, wherein:
the base station is further configured to store the modulated mixes of acoustic electrical signals in acoustic data files.

18. The in-ear monitoring system of claim 17, wherein:
the wireless transceiver is further configured to selectively access the stored acoustic data files over the first wireless communication protocol for playback by the first and second in-ear assemblies.

19. An in-ear monitoring system, comprising:
first and second in-ear assemblies, each in-ear assembly comprising:
an outside microphone configured to receive acoustic energy from an acoustic environment external to a wearer and convert the acoustic energy into ambient electrical signals;
an occlusion microphone configured to receive occlusion acoustic energy from the wearer's inner ear and convert the sounds into occlusion electrical signals;
a communication subsystem configured to receive a mix of acoustic electrical signals;
a digital signal processing (DSP) circuit configured to receive the ambient electrical signals, the occlusion electrical signals, and the mix of acoustic electrical signals and process the electrical signals according to in-ear assembly processing parameters to generate an output signal having a reduced occlusion characteristic; and
an output transducer configured to receive the output signal and convert the output signal into an acoustic signal heard by the wearer.

20. The in-ear monitoring system of claim 20, further comprising:
an outside microphone configured to receive acoustic energy from an acoustic environment external to the wearer and convert the acoustic energy into corresponding ambient electrical signals; and
wherein the DSP circuit is further configured to receive and provide ambient compression to the ambient electrical signals to generate the output signal.

21. A method of in-ear monitoring, comprising:
in first and second in-ear assemblies:
receiving acoustic energy from an acoustic environment external to a wearer of the first and second in-ear assemblies;
converting the acoustic energy into corresponding ambient electrical signals;
receiving a mix of acoustic electrical signals;
providing ambient compression to the ambient electrical signals;
processing the ambient electrical signals and the mix of acoustic electrical signals according to in-ear assembly processing parameters to provide an output signal; and
converting the output signal into an acoustic signal heard by the wearer.

22. The method of claim 21, further comprising:
providing ambient compression only during the presence of ambient compression activation signal.

23. The method of claim 21, wherein:
providing ambient compression to the ambient electrical signals comprises limiting the ambient sound pressure level (SPL) to a maximum ambient SPL threshold level.

24. A method of in-ear monitoring, comprising:
in first and second in-ear assemblies:
receiving a mix of acoustic electrical signals over a first wireless protocol;
processing the mix of acoustic electrical signals according to in-ear assembly processing parameters to provide an output signal; and
converting the output signal into an acoustic signal heard by a wearer of the first and second in-ear assemblies;
receiving the mix of acoustic electrical signals from a base station over a second wireless protocol; and
transmitting the mix of acoustic electrical signals from the base station to the first and second in-ear assemblies over the first wireless protocol.

25. The method of claim 24, wherein:
the first wireless protocol conforms to a personal area network (PAN) protocol and the second wireless protocol conforms to a wireless local area network (WLAN) protocol.

26. The method of claim 24, further comprising:
addressing a plurality of paired first and second in-ear assemblies;
modulating the mix of acoustic electrical signals according to modulation settings associated with each addressed pair of first and second in-ear assemblies; and
addressing the modulate mix of acoustic electrical signals to correspondingly addressed pairs of first and second in-ear assemblies in accordance with the second wireless protocol.

27. The method of claim 26, further comprising:
selectively receiving the modulated mixes of acoustic electrical signals based on a user selection.

28. The method of claim 26 further comprising:
storing the modulated mixes of acoustic electrical signals in acoustic data files.

29. The method of claim 28 further comprising:
selectively accessing the stored acoustic data files for playback by first and second in-ear assemblies.

30. A method of in-ear monitoring, comprising:
in first and second in-ear assemblies:
receive occlusion acoustic energy from an inner ear of a wearer of the first and second in-ear assemblies;
converting the occlusion acoustic energy into occlusion electrical signals;
receiving a mix of acoustic electrical signals;
providing ambient compression to the ambient electrical signals;
processing the occlusion electrical signals and the mix of acoustic electrical signals according to in-ear assembly processing parameters to provide an output signal; and
converting the output signal into an acoustic signal having a reduced occlusion characteristic heard by the wearer.
